(19) United States
(12) Patent Application Publication
(10) Pub. No.: US 2004/0098438 A1
(43) Pub. Date: May 20, 2004

(54) Method of generating a multiply accumulator with an optimum timing and generator thereof

(75) Inventor: Jui Chi Chung, Kaohsiung (TW)

Correspondence Address: BACON & THOMAS, PLLC, 625 SLATERS LANE, FOURTH FLOOR, ALEXANDRIA, VA, 22314

(73) Assignee: Faraday Technology Corp., Hsinchu (TW)

(21) Appl. No.: 10/320,458

(22) Filed: Dec. 17, 2002

(30) Foreign Application Priority Data
Nov. 14, 2002 (TW) 91133455

(51) Int. Cl. G06F 7/38

(52) U.S. Cl. 708/523

(57) ABSTRACT

A multiply accumulator with an optimum timing performs multiplications and additions at the same time by commonly accumulating partial products and addends. First of all, timings of bits of the partial products and timings of bits of the addend are defined. A sum delay parameter and a carry delay parameter associated with adders to be used for constructing the multiply accumulator are retrieved from a circuit design standard cell library. Based on the timings of bits of the partial products and the addend, and the sum delay and carry delay parameters, the bits of the partial products and the addend are assigned to input terminals of the adders, and the input and output terminals of the adders are interconnected by using a three dimensional reduction method. Finally, a net list representative of the multiply accumulator with the optimum timing is output.

### BACKGROUND OF THE INVENTION

1. Field of the Invention

The present invention relates to a method of generating a multiply accumulator and a generator thereof. More particularly, the present invention relates to a method of generating a multiply accumulator with an optimum timing, base on timings of input signals and delay parameters of adders used to construct the multiply accumulator, which is applicable in high-speed digital signal processing, and a generator thereof.

2. Description of the Related Art

Typically, digital electronic products are equipped with microprocessors for performing logical operations and arithmetical operations with respect to digital signals. The arithmetical operation of the digital signals normally includes a series of multiplications and accumulations (or referred to as additions), which are carried out by means of a multiply accumulator. FIGS. 1(a) and 1(b) are schematic diagrams showing two examples of configurations of conventional multiply accumulators for performing a multiplication-and-addition operation X·Y+A. In this operation, the two multipliers X and Y as well as the addend A are all digital signals consisting of a plurality of bits, such as 16 or 32 bits. Also, the symbol · indicates a multiplication while the symbol + indicates an addition.

Referring to FIG. 1(a), a conventional multiply accumulator 1 includes a carry save adder tree 10 and an adder 11. First, the two multipliers X and Y are input into the carry save adder tree 10 for performing the multiplication X·Y by accumulation of partial products. Typically, the carry save adder tree 10 has a configuration of a plurality of adders (not shown) interconnected as a tree structure for performing the accumulation of the partial products of the multipliers X and Y. After completing the multiplication X·Y, the carry save adder tree 10 outputs a final product into the adder 11 for performing the addition with respect to the addend A. Therefore, the arithmetical multiplication-and-addition operation X·Y+A is completed.

Another conventional multiply accumulator 2 shown in FIG. 1(b) has a configuration different from that shown in FIG. 1(a) in that the conventional multiply accumulator 2 further includes a Booth encoder 12. As shown in FIG. 1(b), the multipliers X and Y are input into the carry save adder tree 10 through the Booth encoder 12. With the Booth encoder 12, the realization of the multiplication X·Y has become easier in the carry save adder tree 10, thereby raising the overall processing speed of the arithmetical multiplication-and-addition operation X·Y+A.

Along with a growing demand for a microprocessor with a better performance, it is necessary to raise the operating speed of the multiply accumulator employed in the microprocessor. Both of the conventional multiply accumulators 1 and 2 shown in FIGS. 1(a) and 1(b) perform the multiplication and the addition in such two separate steps that the addition does not be carried out until the completion of the multiplication. As a result, the overall operating speed of the conventional multiply accumulators 1 and 2 are inevitably restrained from optimization since the addend remains idle before the addition can be performed.

### SUMMARY OF THE INVENTION

In view of the above-mentioned problem, an object of the present invention is to provide a method of generating a multiply accumulator with an optimum timing and a generator thereof, in which the optimum timing is achieved by simultaneously performing multiplications and additions through accumulating partial products and addend in a common step.

Another object of the present invention is to provide a method of generating a multiply accumulator with an optimum timing and a generator thereof, in which a plurality of adders used to construct the multiply accumulator are interconnected in accordance with the optimum timing based on timings of partial products and addend as well as delay parameters of the adders.

According to one aspect of the present invention, a method of generating a multiply accumulator with an optimum timing includes: defining an arithmetical operation consisting of at least one multiplication and at least one addition, wherein the at least one multiplication is multiplying a first multiplier with a second multiplier while the at least one addition is adding a product of the first multiplier and the second multiplier with an addend; generating a plurality of partial products associated with the first and the second multipliers; defining timings of bits of the plurality of partial products and timings of bits of the addend; selecting a plurality of adders to be used for constructing the multiply accumulator; retrieving a sum delay parameter and a carry delay parameter, associated with the plurality of adders, from a circuit design standard cell library; assigning the bits of the plurality of partial products and the bits of the addend to input terminals of the plurality of adders and interconnecting the input terminals and output terminals of the plurality of adders, by using an algorithm called three dimensional reduction method, based on the timings of the bits of the plurality of partial products, the timings of the bits of the addend, and the sum delay parameter and the carry delay parameter; generating and coupling a carry propagate adder to the plurality of adders based on timings of bits calculated by using the algorithm called three dimensional reduction method; and outputting a net list representative of the multiply accumulator with the optimum timing.

In the present invention, because the partial products and the addend are commonly accumulated in a single step, i.e., the multiplications and the additions are performed simultaneously, so the multiply accumulator according to the present invention achieves an optimum timing without idle periods of the addend. Moreover, because the adders used to construct the multiply accumulator are interconnected in accordance with the optimum timing based on the timings of the partial products and the addend as well as delay parameters of the adders, so the present invention is applicable to various timing conditions, adder types, and delay parameters, and generates corresponding multiply accumulators with the optimum timings.

### BRIEF DESCRIPTION OF THE DRAWINGS

The above-mentioned and other objects, features, and advantages of the present invention will become apparent with reference to the following descriptions and accompanying drawings, wherein:

FIGS. 1(a) and 1(b) are schematic diagrams showing two examples of configurations of conventional multiply accumulators for performing a multiplication-and-addition operation X·Y+A;

FIG. 2 is a schematic diagram showing an operation of a generator of a multiply accumulator with an optimum timing according to the present invention;

FIG. 3 is a schematic diagram showing an algorithm for commonly accumulating partial products and an addend according to the present invention; and

FIG. 4 is a flow chart showing a method of generating a multiply accumulator with an optimum timing according to the present invention.

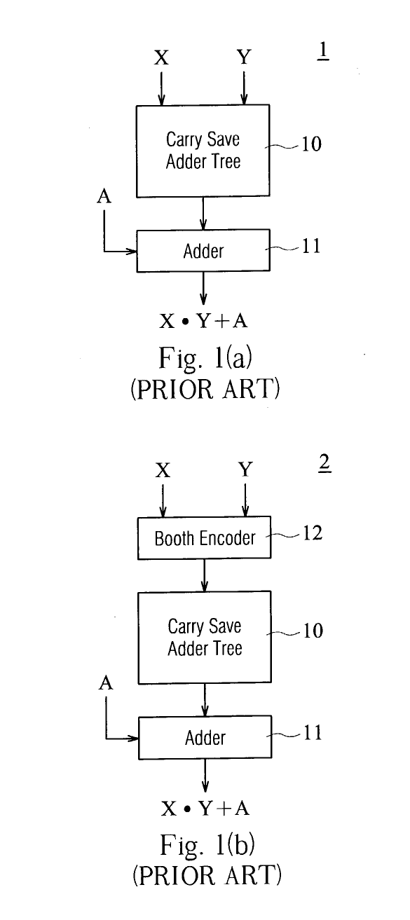

### DETAILED DESCRIPTION OF THE PREFERRED EMBODIMENTS

The preferred embodiments according to the present invention will be described in detail with reference to the drawings.

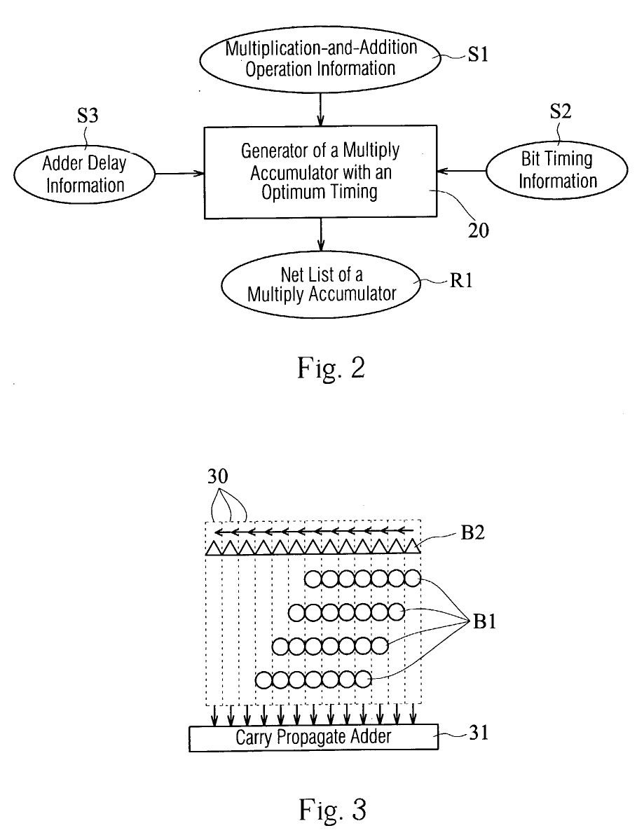

FIG. 2 is a schematic diagram showing an operation of a generator of a multiply accumulator with an optimum timing according to the present invention. Referring to FIG. 2, a generator 20 of a multiply accumulator with an optimum timing may be a computer used to perform a method of generating a multiply accumulator with an optimum timing according to the present invention. As required input data, the generator 20 of a multiply accumulator with an optimum timing receives a multiplication-and-addition operation information S1, a bit timing information S2, and an adder delay information S3.

More specifically, the multiplication-and-addition operation information S1 is used to define an arithmetical operation consisting of at least one multiplication and at least one addition. The multiplication is multiplying a first multiplier with a second multiplier while the addition is adding a product of the first multiplier and the second multiplier with an addend. For example, the multiplication-and-addition operation information S1 defines an arithmetical multiplication-and-addition operation of X·Y+A where X and Y are the first and second multipliers, respectively, and A is the addend. The bit timing information S2 provides timings of bits of partial products of the multipliers as well as timings of bits of the addend. The adder delay information S3 provides sum delay parameters and carry delay parameters associated with adders used to construct the multiply accumulator. Normally, the adder receives signals to be added and outputs a sum signal and a carry signal. There are time lags between the event of receiving signals and the event of outputting signals since the operation of the adder inherently takes some time. The sum delay parameter is representative of a time lag when the sum signal is output from the adder while the carry delay parameter is representative of a time lag when the carry signal is output from the adder.

Based on the multiplication-and-addition operation information S1, the bit timing information S2, and the adder delay information S3, the generator 20 of a multiply accumulator with an optimum timing, by using an algorithm called “three dimensional reduction method”, assigns bits of the partial products of the first and second multipliers X and Y as well as bits of the addend A to input terminals of the adders and sets up interconnections between the input terminals and output terminals of the adders, thereby presenting a design layout of a multiply accumulator with an optimum timing. Finally, the generator 20 of a multiply accumulator with an optimum timing outputs a net list R1 representative of a multiply accumulator with an optimum timing.

The three dimensional reduction method (TDM) employed in the present invention has been described in “A Method for Speed Optimized Partial Product Reduction and Generation of Fast Parallel Multipliers Using an Algorithmic Approach,” IEEE Transactions on Computers, VOL. 45, No. 3, March 1996, by Oklobdzija et al. This document is incorporated herein by reference.

FIG. 3 is a schematic diagram showing an algorithm for commonly accumulating partial products and an addend according to the present invention. Referring to FIG. 3, a symbol ◯ is representative of each bit B1 of the partial products while a symbol Δ is representative of each bit B2 of the addend. Through the above-mentioned three dimensional reduction method, the bits B1 of the partial products and the bit B2 of the addend arranged in each of vertical slices 30 are accumulated in accordance with an optimum timing determined by the bit timing information S2 and the adder delay information S3. Leftward arrows shown in FIG. 3 indicate horizontal propagations of the vertical slices 30 while downward arrows indicate the carry and sum bits generated from the accumulations of the vertical slices 30 are connected to a final adder, e.g., a carry propagate adder 31.

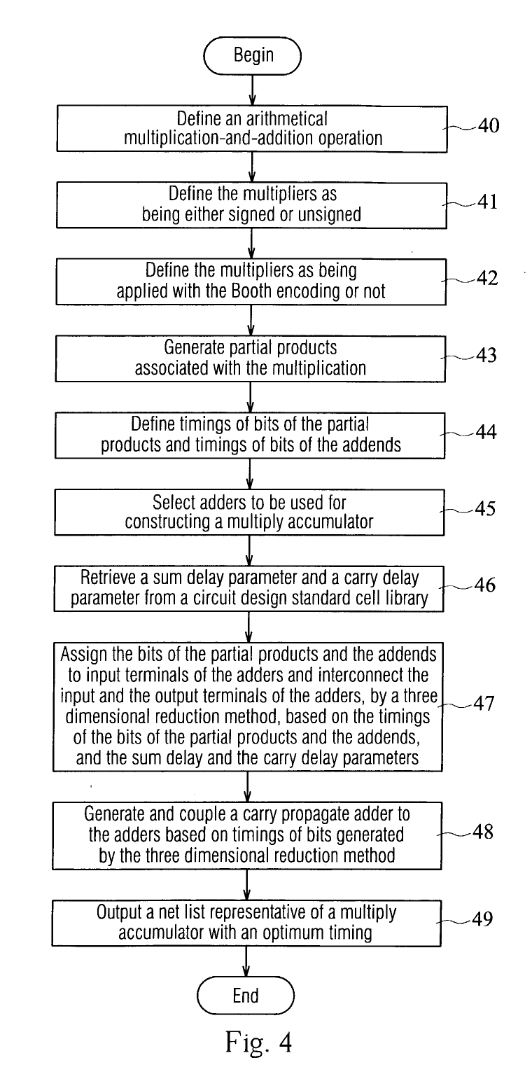

FIG. 4 is a flow chart showing a method of generating a multiply accumulator with an optimum timing according to the present invention. Referring to FIG. 4, at first, an arithmetical operation consisting of at least one multiplication and at least one addition is defined in a step 40. The multiplication is multiplying a first multiplier with a second multiplier while the addition is adding a product of the first multiplier and the second multiplier with an addend. For example, an arithmetical operation of X·Y+A is defined in the step 40, where X and Y are the first and second multipliers, respectively, and A is the addend.

Next, each of the multipliers is defined as being either signed or unsigned in a step 41. In a step 42, each of the multipliers is defined as being applied with the Booth encoding or not. Next in a step 43, a plurality of partial products associated with the at least one multiplication are generated. Next in a step 44, timings of bits of the partial products and timings of bits of the addend are defined.

Next, in a step 45, a plurality of adders, such as adders in 1.0μ CMOS technology, is selected to be used for constructing the multiply accumulator. Next in a step 46, a sum delay parameter and a carry delay parameter associated with the adders to be used are retrieved from a circuit design standard cell library.

Next in a step 47, based on the timings of bits of the partial products, the timings of bits of the addend, and the sum delay parameter and the carry delay parameter, the bits of the partial products and the bits of the addend are assigned to input terminals of the adders to be used, and the input terminals and output terminals of the adders to be used are interconnected by using an algorithm called “three dimensional reduction method”. Next in a step 48, based on timings of bits calculated by using the three dimensional reduction method, a carry propagate adder is generated and coupled to the adders which has been interconnected in the step 47. Finally in a step 49, a net list is generated as an output representative of a multiply accumulator with an optimum timing.

In the present invention, because the partial products and the addend are commonly accumulated in a single step, i.e., the multiplications and the additions are performed simultaneously, so the multiply accumulator according to the present invention achieves an optimum timing without idle periods of the addend. Similarly, when the present invention is applied to a more complicated multiplication-and-addition operation, such as X·Y+M·N+A, it is still possible to commonly accumulate the partial products and the addend, thereby generating a multiply accumulator with an optimum timing.

In the present invention, because the adders used to construct the multiply accumulator are interconnected in accordance with the optimum timing based on the timings of the partial products and the addend as well as delay parameters of the adders, so the present invention is applicable to various timing conditions, adder types, and delay parameters, and generates corresponding multiply accumulators with the optimum timings.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A method of generating a multiply accumulator with an optimum timing, comprising steps of:
defining an arithmetical operation consisting of at least one multiplication and at least one addition, wherein the at least one multiplication is multiplying a first multiplier with a second multiplier while the at least one addition is adding a product of the first multiplier and the second multiplier with an addend;
generating a plurality of partial products associated with the first and the second multipliers;
defining timings of bits of the plurality of partial products and timings of bits of the addend;
selecting a plurality of adders to be used for constructing the multiply accumulator;
retrieving a sum delay parameter and a carry delay parameter, associated with the plurality of adders, from a circuit design standard cell library;
assigning the bits of the plurality of partial products and the bits of the addend to input terminals of the plurality of adders and interconnecting the input terminals and output terminals of the plurality of adders, by using an algorithm called three dimensional reduction method, based on the timings of the bits of the plurality of partial products, the timings of the bits of the addend, and the sum delay parameter and the carry delay parameter;
generating and coupling a carry propagate adder to the plurality of adders based on timings of bits calculated by using the algorithm called three dimensional reduction method; and
outputting a net list representative of the multiply accumulator with the optimum timing.

2. The method according to claim 1, further comprising a step of:
defining the first and the second multipliers as being either singed or unsigned after the step of defining the arithmetical operation.

3. The method according to claim 1, further comprising a step of:
applying a Booth encoding to the first and second multipliers after the step of defining the arithmetical operation.

4. A generator of a multiply accumulator with an optimum timing, comprising:
means for defining an arithmetical operation consisting of at least one multiplication and at least one addition, wherein the at least one multiplication is multiplying a first multiplier with a second multiplier while the at least one addition is adding a product of the first multiplier and the second multiplier with an addend;
means for generating a plurality of partial products associated with the first and the second multipliers;
means for defining timings for bits of the plurality of partial products and timings for bits of the addend;
means for selecting a plurality of adders to be used for constructing the multiply accumulator;
means for retrieving a sum delay parameter and a carry delay parameter, associated with the plurality of adders, from a circuit design standard cell library;
means for assigning the bits of the plurality of partial products and the bits of the addend to input terminals of the plurality of adders and interconnecting the input terminals and output terminals of the plurality of adders, by using an algorithm called three dimensional reduction method, based on the timings of the bits of the plurality of partial products, the timings of the bits of the addend, and the sum delay parameter and the carry delay parameter;
means for generating and coupling a carry propagate adder to the plurality of adders based on timings of bits calculated by using the algorithm called three dimensional reduction method; and
means for outputting a net list representative of the multiply accumulator with the optimum timing.

5. The generator according to claim 4, further comprising:
means for defining the first and the second multipliers as being either singed or unsigned after the step of defining the arithmetical operation.

6. The generator according to claim 4, further comprising:
means for applying a Booth encoding to the first and second multipliers after the step of defining the arithmetical operation.
